(19) United States
(12) Patent Application Publication
(10) Pub. No.: US 2010/0169048 A1
(43) Pub. Date: Jul. 1, 2010

(54) MAINTENANCE PLANNING METHOD

(75) Inventors: Klaus Hanreich, Wedemark (DE); Rolf Burmeister, Rodewald (DE); Torsten Petrick, Wedemark (DE); Ferdinand Exler, Apelern (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/441,303

(22) PCT Filed: Sep. 7, 2007
(86) PCT No.: PCT/DE2007/001620

§ 371 Date: Oct. 5, 2009

(30) Foreign Application Priority Data
Sep. 14, 2006 (DE) 10 2006 043 292.4

(51) Int. Cl. G06F 15/00

(52) U.S. Cl. 702/184

(57) ABSTRACT

A maintenance planning method for turbomachines, especially for gas turbine aircraft engines, is disclosed. In an embodiment, the method includes: a) data obtained from the previous maintenance of turbomachines is stored in a database in a structured manner, where the data especially correlates maintenance work carried out with operating loads of a serviced turbomachine; b) in order to pre-plan the maintenance of a turbomachine undergoing further maintenance, the maintenance work to be carried out is planned in terms of type and sequence on the basis of the database; and c) the turbomachine undergoing further maintenance is inspected for the final planning of the maintenance, and the type and/or sequence of the maintenance work to be carried out, which was specified during the pre-planning of the maintenance, is adapted and/or supplemented on the basis of the inspection.

This application claims the priority of International Application No. PCT/DE2007/001620, filed Sep. 7, 2007, and German Patent Document No. 10 2006 043 292.4, filed Sep. 14, 2006, the disclosures of which are expressly incorporated by reference herein.

### BACKGROUND AND SUMMARY OF THE INVENTION

The invention relates to a maintenance planning method for turbomachines, especially for gas turbine aircraft engines.

The procedure for servicing gas turbine aircraft engines in accordance with established practice is that maintenance intervals are determined strictly by hours of operation or hours flown and/or the number of take-offs and/or the number of landings completed by a gas turbine aircraft engine. In practice, a to-be-serviced gas turbine aircraft engine is inspected, wherein the maintenance work is specified solely on the basis of this inspection of the gas turbine aircraft engine. The disadvantage of this procedure known from practice for the maintenance of gas turbine aircraft engines is that maintenance work to be carried out cannot be scheduled prior to the inspection of a gas turbine aircraft engine. This imposes a limit on reducing processing times for the maintenance of gas turbine aircraft engines.

Starting herefrom, the current invention is based on the objective of creating a more efficient and more variable maintenance planning method for turbomachines, especially for gas turbine aircraft engines.

The inventive maintenance planning method comprises at least the following steps: a) data obtained from the previous maintenance of turbomachines is stored in a database in a structured manner, wherein the data especially correlates maintenance work carried out with operating loads of a serviced turbomachine; b) in order to pre-plan the maintenance of a turbomachine undergoing further maintenance, the maintenance work to be carried out is planned in terms of type and sequence on the basis of the database; c) the turbomachine undergoing further maintenance is inspected for the final planning of the maintenance, and the type and/or sequence of the maintenance work to be carried out, which was specified during the pre-planning of the maintenance, is adapted and/or supplemented on the basis of the inspection.

In terms of the inventive method, empirical values from previous maintenance are used in order to pre-plan upcoming maintenance of a turbomachine. The inspection of the turbomachine is performed following the pre-planning of the maintenance, wherein the pre-planning of the maintenance is adjusted and/or supplemented on the basis of the inspection in order to obtain the final planning of the maintenance.

Consequently, the inventive method makes it possible to pre-plan the technical process of the maintenance, conduct resource planning of machines and personnel required for maintenance as well as pre-plan the processing schedule prior to the inspection in order to ultimately reduce processing times for the maintenance of a turbomachine, especially of a gas turbine aircraft engine.

Preferred further developments of the invention are disclosed in the following description.

### DETAILED DESCRIPTION OF THE INVENTION

The present invention relates to a method for planning the maintenance for turbomachines such as gas turbine aircraft engines, wherein the processing time required for the maintenance may be reduced by means of the inventive maintenance planning method.

The method is used preferably in the planning of maintenance of gas turbine aircraft engines, however, it is not restricted to this application, rather it may also be used in the planning of maintenance of other turbomachines such as stationary gas turbines.

In terms of the inventive method, data obtained from the previous maintenance of gas turbine aircraft engines is stored in a database in a structured manner, wherein the data especially correlates maintenance work carried out with operating loads of a serviced gas turbine aircraft engine.

In particular, maintenance work such as component cleaning and/or component coating removal and/or component coating and/or component replacement is correlated with operating loads such as the number of hours of operation or the number of hours flown and/or the number of take-offs and/or the number of landings. In the process, these correlations are stored in a structured manner in the database in the form of decision trees containing case decisions.

In order to pre-plan the maintenance of a gas turbine aircraft engine undergoing further maintenance, the maintenance work to be carried out is planned in terms of type and sequence on the basis of the database. Furthermore, a point in time for maintenance may be specified for the gas turbine aircraft engine undergoing further maintenance on the basis of the database in order to thereby specify the optimum point in time for maintenance on the basis of the operating loads of a gas turbine aircraft engine that is to be serviced.

The pre-planning of the maintenance is performed solely on the basis of the empirical values from previous engine maintenance stored in a structured manner in the database and without inspecting the gas turbine aircraft engine to be serviced.

Following the pre-planning of the maintenance on the basis of the database, the gas turbine aircraft engine undergoing maintenance is inspected, wherein the type and/or sequence of the maintenance work to be carried out, which was specified during the pre-planning of the maintenance, is adapted and/or supplemented on the basis of the inspection, in order to carry out the final planning of the maintenance. Consequently, in terms of the present invention, a pre-planning of the maintenance that has been prepared in advance is merely modified on the basis of the inspection.

Because of the inventive use of empirical values from preceding engine maintenance, it is possible to pre-plan the required scope of maintenance in terms of pre-planning the maintenance for a gas turbine aircraft engine undergoing further maintenance. This pre-planning of the maintenance is performed without the prior inspection of the gas turbine aircraft engine. The appraisal or inspection of the gas turbine aircraft engine is performed after the pre-planning of the maintenance as a separate step and merely entails adapting and/or supplementing the maintenance work specified during the pre-planning of the maintenance. As a result, maintenance work can be prognosticated in a timely manner and be incorporated into technical process planning, resource planning and process scheduling. This makes it possible to considerably reduce processing times for the maintenance of gas turbine aircraft engines.

The empirical values from past maintenance processes are stored as technical interrelationships in a structured manner in decision trees, whereby any combinations of possible technical decisions may be represented. The decision trees contain case decisions in order to store the empirical values or data from maintenance that has already been performed in a structured manner and draw upon them for pre-planning of the maintenance in the case of new maintenance that is to be performed.

1-3. (canceled)

4. A maintenance planning method for a turbomachine, comprising the steps of:
storing data obtained from a previous maintenance of turbomachines in a database in a structured manner, wherein the data correlates maintenance work carried out with operating loads of a serviced turbomachine;
pre-planning a maintenance of a turbomachine, wherein the maintenance to be carried out is planned in terms of a type and a sequence on a basis of the database; and
inspecting the turbomachine that is to receive the maintenance for a final planning of the maintenance, wherein in the final planning the type and/or the sequence of the maintenance to be carried out, which was specified during the pre-planning of the maintenance, is adapted and/or supplemented on a basis of the inspection.

5. The maintenance planning method according to claim 4, wherein a point in time for the maintenance to be carried out is specified for the turbomachine on the basis of the database.

6. The maintenance planning method according to claim 4, wherein:
the data is stored in the structured manner in a form of decision trees such that the data correlates the maintenance work carried out of component cleaning and/or component coating removal and/or component coating and/or component replacement with the operating loads of a number of hours of operation and/or a number of take-offs and/or a number of landings.

7. The maintenance planning method according to claim 4, wherein the turbomachine is a gas turbine aircraft engine.
